(19) United States
(12) Patent Application Publication
(10) Pub. No.: US 2011/0071245 A1
(43) Pub. Date: Mar. 24, 2011

(54) Rubber Mixture with Low Heat Build-Up and Method of Producing Tire Parts

(75) Inventors: Julian De-Riva Perez, Gijon (ES); Christian Weber, Garbsen (DE); Thomas Kramer, Herford (DE); Philipp Koelle, Hannover (DE)

(73) Assignee: CONTINENTAL REIFEN DEUTSCHLAND GMBH, Hannover (DE)

(21) Appl. No.: 12/886,030

(22) Filed: Sep. 20, 2010

Related U.S. Application Data
(63) Continuation of application No. PCT/EP2009/051881, filed on Feb. 18, 2009.

(30) Foreign Application Priority Data
Mar. 19, 2008 (DE) 102008015023.1

(51) Int. Cl. C08K 3/22

(52) U.S. Cl. 524/432

(57) ABSTRACT

A rubber mixture is ideally suited for producing pneumatic vehicle tires, belts, and straps. The rubber mixture has the following composition: 95-100 phr at least of a natural or synthetic polyisoprene, 0-5 PHR at least of an additional polar or non-polar rubber, 1-10 phr silicic acid, 20-40 phr at least of a carbon black having an iodine fraction less than or equal to 120 g/kg and a DBP fraction greater than or equal to 90 cm3/100 g, 0.1-5 phr at least of a plasticizer oil, 0.1-10 phr zinc oxide, and 2-100 phr of other additives.

### CROSS-REFERENCE TO RELATED APPLICATION

This is a continuation application, under 35 U.S.C. §120, of copending international application No. PCT/EP2009/051881, filed Feb. 18, 2009, which designated the United States; this application also claims the priority, under 35 U.S.C. §119, of German patent application No. DE 10 2008 015 023.1, filed Mar. 19, 2008; the prior applications are herewith incorporated by reference in their entirety.

### BACKGROUND OF THE INVENTION

### Field of the Invention

The invention relates to a rubber mixture, especially for motor vehicle pneumatic tires, belts and drive belts.

Since the running characteristics of a tire, especially a motor vehicle pneumatic tire, are dependent to a high degree on the rubber composition of the tread, particularly high demands are made on the composition of the tread mixture. Thus, various attempts have been made to positively influence the properties of the tire by the variation of the polymer components, of the fillers and of the other additives in the tread mixture. In doing this, it has to be taken into account that an improvement in one tire characteristic often entails a deterioration in another characteristic. For instance, an improvement in the heat buildup is usually associated with a poorer abrasion performance of the tire. Heat buildup is directly connected to rolling resistance. The higher the heat buildup, the poorer the rolling resistance.

In order to improve the thermal durability and/or the rolling resistance of motor vehicle tires, the tread is frequently divided. The upper part, known as the “cap”, is relatively abrasion- and cut-resistant, while the lower part, known as the “base”, is a mixture with particularly low heat buildup.

To date, heat buildup has been optimized, especially for the base mixture, either by providing the mixture with high proportions by weight of a low-structure carbon black or using comparatively expensive carbon black with a high surface activity. In the case of the latter measure, it is usually necessary also to add a not inconsiderable amount of silica or zinc oxide.

Both measures, however, have the disadvantage that the low heat buildup is obtained at the expense of abrasion performance.

South Korean patent application KR 20040091169 describes a rubber mixture for the sidewall of truck tires with improved fatigue performance and improved ozone protection. The rubber mixture contains a combination of butadiene rubber and natural rubber in a ratio of 30˜70/70˜30 and 45-50 parts by weight of carbon black with an iodine absorption number in the range of 64-70 m²/g and a DBP number in the range of 115-225 m²/100 g. In addition, it contains 2.5-8 parts by weight of silica with 0.4-1.2 parts by weight of a silica binder.

Japanese patent application JP 2005336303 A discloses a motor vehicle pneumatic tire containing a rubber mixture with improved abrasion performance, improved wet traction and low heat buildup, containing 30-80 parts by weight of natural rubber and 20-70 parts by weight of butadiene rubber and/or styrene-butadiene rubber. In addition, the rubber mixture contains 40-60 parts by weight of filler, of which 30-70 percent by weight is silica and 5-20 percent by weight is silica binder.

Japanese patent application JP 8073657 A describes a motor vehicle pneumatic tire with improved abrasion, improved ageing resistance, improved wet traction and improved performance on ice and snow. The motor pneumatic vehicle tire contains a tread mixture containing 60 phr or less of carbon black with a nitrogen surface area of 120 m²/g or higher, and 5-40 phr of silica and 80% by weight or more natural rubber and butadiene rubber. In addition, the rubber mixture contains a low molecular weight, liquid diene rubber.

A motor vehicle tire with improved rolling resistance, improved handling properties and improved abrasion performance is known from published European patent application EP 1593528 A, corresponding to U.S. patent publication No. 20050272852. The tire contains a rubber mixture containing 55-98 phr of natural rubber, 2-45 phr of butadiene rubber with a molecular weight less than 200 000 g/mol, 0-20 phr of at least one further diene rubber and 30-120 phr of filler containing 30-120 phr of carbon black and 0-60 phr of amorphous synthetic silica. A silane coupling agent is likewise present, and some or all of the carbon black has been surface-treated with silica.

German Utility Model DE 69823479 T2 provides a rubber mixture which enables improvement of rolling resistance without influencing the abrasion resistance and wet traction. The rubber mixture contains at least two different copolymers, a first reinforcer filler based on carbon black and having a DBP number of at least 110 ml/100 g, and a second reinforcer filler based on siliceous earth, in an amount such that the sum of first and second reinforcing fillers is between 50 and 100 phr and both are present distributed homogeneously in the polymer base.

Japanese patent application JP 200239452 A describes an abrasion-resistant rubber mixture which contains 100 parts by weight of natural rubber and/or synthetic diene rubber, 10 parts by weight of silica, 0-90 parts by weight of carbon black and 2-10 parts by weight of ester and fatty acids.

Japanese patent application JP 2003012860 A discloses a rubber mixture with excellent abrasion performance, good processability and good tear properties. The rubber mixture contains 35-90 phr of natural and/or synthetic natural rubber, 10-65 phr of butadiene rubber, 45-60 phr of carbon black, 2-10 phr of silica and 2-10 phr of modified liquid butadiene rubber.

### SUMMARY OF THE INVENTION

It is accordingly an object of the invention to provide a rubber mixture with low heat build-up and a method of producing tire parts especially belts and drive belts which overcome the above-mentioned disadvantages of the prior art methods and devices of this general type, which brings about a further improvement with regard to the conflict between heat buildup and abrasion.

The object is achieved by a rubber mixture with the following composition: 95-100 phr of at least one natural or synthetic polyisoprene, 0-5 phr of at least one further polar or nonpolar rubber, 1-10 phr of silica, 20-40 phr of at least one carbon black with an iodine number less than or equal to 120 g/kg and a DBP number greater than or equal to 90 cm³/100 g, 0.1-5 phr of at least one plasticizer oil, 0.1-10 phr of zinc oxide, and 2-100 phr of further additives.

The unit phr (parts per hundred of rubber by weight) used in this document is the unit of amount typically used in the rubber industry for mixing formulations. The dosage of the parts by weight of the individual substances is always based on 100 parts by weight of the total mass of all rubbers present in the mixture.

It has been found that, surprisingly, the combination of a comparatively high proportion by weight of natural and/or synthetic polyisoprene and particular carbon black types, and of a small amount of silica which is not attached or is attached partly or fully by a suitable silane coupling agent, causes the abrasion value to remain at the same level or even to improve, and the heat buildup to decrease, i.e. the rolling resistance to improve. It is thus possible to decouple the target conflict between heat buildup and abrasion. This is true not only for the motor vehicle tire tread, more particularly for the base in the case of a divided tread, but also for further inner tire components. The rubber mixtures for the further inner tire components are combined hereinafter, and are also referred to as body compounds or body mixtures as is customary in tire technology.

The inventive rubber mixture is also employed in developing the mixture for drive belts and other belts, especially for conveyor belts. In daily use, especially the running side of conveyor belts is subject to high mechanical stresses, for example on deflection at drive drums, steering drums and/or guide drums, to withstand the tensile forces which occur. Therefore, the abrasion resistance is of great significance here too with the same further viscoelastic properties, for example rebound elasticity, to ensure a long lifetime.

The rubber mixture contains 95-100 phr, preferably 95-99.9 phr, of at least one natural or synthetic polyisoprene, and 0-5 phr, preferably 0.1-5 phr, of a further polar or nonpolar rubber.

The polar or nonpolar rubber is selected from the group consisting of butadiene rubber and/or styrene-butadiene rubber and/or solution-polymerized styrene-butadiene rubber and/or emulsion-polymerized styrene-butadiene rubber and/or liquid rubbers and/or halobutyl rubber and/or polynorbornene and/or isoprene-isobutylene copolymer and/or ethylene-propylene-diene rubber and/or nitrile rubber and/or chloroprene rubber and/or acrylate rubber and/or fluoro rubber and/or silicone rubber and/or polysulfide rubber and/or epichlorohydrin rubber and/or styrene-isoprene-butadiene terpolymer.

Especially styrene-isoprene-butadiene terpolymer, butyl rubber, halobutyl rubber or ethylene-propylene-diene rubber are used in the production of conveyor belts.

It is preferred when the further polar or nonpolar rubber is at least one butadiene rubber and/or at least one styrene-butadiene rubber, which may be solution-polymerized or emulsion-polymerized.

The inventive rubber mixture contains 1-10 phr, preferably 1-7 phr, more preferably 1-5 phr, of silica 0-10 phr of this total amount of silica may be bonded to the polymer matrix by a coupling agent, preferably silane, and/or 0-10 phr may not be bonded to the polymer matrix. This means that, proceeding from the total amount of silica, all or only some of it is bonded to the polymer matrix by the coupling agent, or there is no bonding at all of the silica to the polymer matrix.

The silicas used in the tire industry are generally precipitated silicas which are characterized especially by their surface area. For characterization, the nitrogen surface area (BET) to DIN 66131 and DIN 66132 is reported as a measure of the inner and outer filler surface area in m²/g, and the CTAB surface area to ASTM D 3765 as a measure of the outer surface area, which is often considered to be the rubber-active surface, in m²/g.

According to the invention, silicas with a nitrogen surface area between 120 and 300 m²/g, preferably between 150 and 250 m²/g, and a CTAB surface area between 120 and 230 m²/g, preferably between 140 and 200 m²/g, are used.

If a coupling agent in the form of silane is used, the amount of the silane is 0-3 phr, preferably 0.1-2 phr. The silane coupling agents used may be all silane coupling agents known to the person skilled in the art for use in rubber mixtures.

The additional introduction of non-bonded silica is a process customary in rubber technology in order to improve the tear properties of rubber mixtures, especially of those for truck treads. However, this has an adverse effect on the heat buildup in the rubber mixture in question, which is manifested in a low rebound elasticity. This is expressed as an increased rolling resistance especially in rubber mixtures for treads for motor vehicle tires. However, the use of bonded silica does lead to an optimization of the tire properties.

To improve the rolling resistance, the use of bonded silica is therefore advisable, whereas the use of non-bonded silica is advisable for rubber mixtures with improved tire properties. A combination of small amounts of bonded and non-bonded silica leads to a compromise solution, such that this allows the target conflict between rolling resistance and friction properties to be controlled.

It is essential to the invention that the rubber mixture contains at least one carbon black with an iodine number less than or equal to 120 g/kg and a DBP number greater than or equal to 90 cm³/100 g. The amount of the carbon black is 20-40 phr, preferably 25-35 phr, more preferably 25-32 phr. In a preferred embodiment, the carbon black has an iodine number to ASTM D 1510, which is also referred to as the iodine absorption number, of less than or equal to 120 g/kg, and a DBP number greater than or equal to 100 cm³/100 g, preferably greater than or equal to 120 cm³/100 g. The DBP number to ASTM D 2414 determines the specific absorption volume of a carbon black or of a light-colored filler by use of dibutyl phthalate. The use of such a carbon black type in the rubber mixture ensures an improvement in the heat buildup without adversely affecting the abrasion performance, which would typically be observed by the person skilled in the art at these comparatively low proportions by weight of carbon black. It is preferred here when only one carbon black type is used in the rubber mixture.

The inventive rubber mixture further contains 0.1-5 phr of at least one plasticizer oil, the plasticizer oil being a mineral oil which is selected from the group consisting of DAE (distillated aromatic extracts) and/or RAE (residual aromatic extract) and/or TDAE (treated distillated aromatic extracts) and/or MES (mild extract solvents) and/or naphthenic oils.

It is possible for another 0-5 phr of at least one further additional plasticizer to be present in the rubber mixture. This further plasticizer may be a synthetic plasticizer and/or a fatty acid and/or a fatty acid derivative and/or a resin and/or a factice.

In addition, the rubber mixture also contains 0.1-10 phr, preferably 0.2-8 phr, more preferably 0.2-4 phr, of zinc oxide.

It is customary to add zinc oxide as an activator, usually in combination with fatty acids (e.g. stearic acid) to a rubber mixture for sulfur crosslinking with vulcanization accelerators. The sulfur is then activated by complex formation for the vulcanization. The conventionally used zinc oxide generally has a BET surface area of less than 10 m²/g. However, it is also possible to use what is known as nano-zinc oxide with a BET surface area of 10 to 60 m²/g.

In addition, the rubber mixture also contains further additives.

Further additives include essentially the crosslinking system (crosslinker, accelerator and retarder), antiozonant, ageing stabilizer, mastication aid and further activators. The proportion of further additives in the total amount is 2 to 100 phr, preferably 3 to 80 phr and more preferably 5-60 phr.

The vulcanization of the rubber mixture is performed in the presence of sulfur or sulfur donors, in which case some sulfur donors can simultaneously act as vulcanization accelerators. Sulfur or sulfur donors are added to the rubber mixture in the last mixing step in the amounts customary to the person skilled in the art (0.4 to 4 phr, sulfur preferably in amounts of 1.5 to 2.5 phr). To control the required time and/or temperature of the vulcanization and to improve the vulcanizate properties, the rubber mixture may contain vulcanization-influencing substances such as vulcanization accelerators, vulcanization retarders which are present in accordance with the invention in the above-described additives, and vulcanization activators as described above.

The inventive rubber mixture is produced by the process customary in the rubber industry, in which a base mixture containing all constituents apart from the vulcanization system (sulfur and vulcanization-influencing substances) is first produced in one or more mixing stages. Addition of the vulcanization system in a last mixing stage produces the finished mixture. The finished mixture is, for example, processed further by an extrusion operation and converted to the corresponding form.

It is a further object of the invention to use the above-described rubber mixture to produce motor vehicle pneumatic tires, especially to produce the tread of a tire and/or a body mixture of a tire, and to produce drive belts and other belts.

For use in motor vehicle pneumatic tires, the mixture is preferably converted to the form of a tread and applied as known in the course of production of the green motor vehicle tire. However, the tread may also be wound onto a green tire in the form of a narrow strip of rubber mixture. When the tread, as described at the outset, is divided into two, the rubber mixture is preferably employed as the mixture for the base.

The inventive rubber mixture for use as a body mixture in motor vehicle tires is produced as already described for the tread. The difference lies in the shaping after the extrusion operation. The forms of the inventive rubber mixture thus obtained for one or more different body mixtures then serve to form a green tire. For use of the inventive rubber mixture in drive belts and other belts, especially in conveyor belts, the extruded mixture is converted to the corresponding form and frequently provided, at the same time or thereafter, with strengthening elements, for example synthetic fibers or steel cord. This usually gives rise to a multilayer structure formed of one and/or more plies of rubber mixture, one and/or more plies of identical and/or different strengthening elements and/or one or more further plies of the same and/or of another rubber mixture.

Other features which are considered as characteristic for the invention are set forth in the appended claims.

Although the invention is described herein as embodied in a rubber mixture with low heat build-up and a method of producing tire parts, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DETAILED DESCRIPTION OF THE INVENTION

The invention will now be illustrated in detail with reference to comparative and working examples compiled in Tables 1 and 2. Table 3 shows the characteristics of the carbon black types used.

In all mixture examples present in the table, the amounts specified are parts by weight based on 100 parts by weight of total rubber (phr).

The mixture was produced under customary conditions in two stages in a laboratory tangential mixture. Specimens were produced from all mixtures by vulcanization, and these specimens were used to determine material properties typical of the rubber industry. For the above-described tests on specimens, the following test methods were employed:
Shore A hardness at room temperature to DIN 53 505;
rebound elasticity at room temperature to DIN 53 512;
stress values at 300% extension at room temperature to DIN 53 504;
tensile strength at room temperature to DIN 53 504;
tear propagation resistance according to Graves at room temperature to DIN 53515; and
abrasion according to Grosch, according to Grosch, K. A., the 131th ACS Rubber Div. Meeting, No. 97, (1987) and Grosch, K. A. et al., Kautschuk Gummi Kunststoffe, 50, 841 (1997).

TABLE 1

| Constituents | Unit | Reference | C1 | C2 |
|---|---|---|---|---|
| Polyisoprene | phr | 100 | 100 | 100 |
| Silica | phr | 5 | 5 | 5 |
| Silane | phr | 0 | 0 | 0 |
| N220 carbon black | phr | 33 | — | — |
| N339 carbon black | phr | — | 30 | 32 |
| Zinc oxide | phr | 3.5 | 3.5 | 3.5 |
| Plasticizer | phr | 2 | 2 | 2 |
| Accelerator | phr | 1.6 | 1.5 | 1.5 |
| Sulfur | phr | 1.4 | 1.7 | 1.7 |

Polyisoprene: SMR 10 CE/CE Regional Rubber-Bukit Mertajam
Silica: Active Silica Gran./PPG Industries Chemicals BV
Zinc oxide: Oxide Gran./AGALSA
Plasticizer: Pristerene 4932/UNIQEMA

TABLE 2

| Properties | Unit | Reference | C1 | C2 |
|---|---|---|---|---|
| Hardness at RT | Shore A | 55.7 | 56.6 | 57.6 |
| Rebound at RT | % | 61.6 | 65.4 | 64.7 |
| 300% stress value | MPa | 9.2 | 10.2 | 10.7 |
| Tensile strength at RT | MPa | 22.9 | 23.2 | 23.7 |
| Graves | N/mm | 61 | 69 | 64 |
| Abrasion | mm³ | 100 | 94 | 108 |

TABLE 3

| | Iodine number | DBP number |
|---|---|---|
| Carbon black | [mg/g] | [cm³/100 g] |
| N220 | 121 | 114 |
| N339 | 90 | 120 |

The reference here is a rubber mixture typically used according to the prior art, as used especially for the base of the tread. In C1, the heat buildup is improved by the addition of a comparatively small amount of carbon black type N339, i.e. the rebound elasticity is increased significantly, which achieves an advantage in the durability and in the rolling resistance of the motor vehicle tire. The further mechanical properties of the rubber mixture, such as hardness, stress at high extension and tensile strength, remain at the same level. The abrasion performance likewise appears to be at virtually the same level. A comparatively slight increase in the carbon black content in the rubber mixture actually leads to a significant increase in the abrasion performance, while there is no demonstrable influence on the heat buildup. It is therefore clearly evident that an inventive rubber mixture solves or at least mitigates the target conflict between heat buildup and abrasion.

1. A rubber mixture, comprising:
95-100 phr of at least one of natural polyisoprene and synthetic polyisoprene;
0-5 phr of at least one further rubber being selected from the group consisting of a further polar rubber and a further nonpolar rubber;
1-10 phr of silica;
20-40 phr of at least one carbon black with an iodine number less than or equal to 120 g/kg and a DBP number greater than or equal to 90 cm³/100 g;
0.1-5 phr of at least one plasticizer oil;
0.1-10 phr of zinc oxide; and
2-100 phr of further additives.

2. The rubber mixture according to claim 1, wherein the further polar rubber and the nonpolar rubber are selected from the group consisting of butadiene rubber, styrene-butadiene rubber, solution-polymerized styrene-butadiene rubber, emulsion-polymerized styrene-butadiene rubber, liquid rubbers, halobutyl rubber, polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, and styrene-isoprene-butadiene terpolymer.

3. The rubber mixture according to claim 1, wherein said further rubber is at least one butadiene rubber.

4. The rubber mixture according to claim 1, wherein said further rubber is at least one styrene-butadiene rubber.

5. The rubber mixture according to claim 4, wherein said styrene-butadiene rubber is a solution-polymerized styrene-butadiene rubber.

6. The rubber mixture according to claim 4, wherein said styrene-butadiene rubber is an emulsion-polymerized styrene-butadiene rubber.

7. The rubber mixture according to claim 1, wherein the rubber mixture contains:
95-99.9 phr of at least one of said natural polyisoprene and said synthetic polyisoprene; and
0.1-5 phr of at least one of said further polar rubber and said further nonpolar rubber.

8. The rubber mixture according to claim 1, wherein the rubber mixture contains 1-7 phr of said silica.

9. The rubber mixture according to claim 8, wherein the rubber mixture contains 1-5 phr of said silica.

10. The rubber mixture according to claim 1, wherein said silica has a BET surface area between 120 and 300 m²/g.

11. The rubber mixture according to claim 1,
further comprising a coupling agent; and
wherein 0-10 phr of a total amount of said silica is bonded to a polymer matrix by said coupling agent.

12. The rubber mixture according to claim 11, wherein said coupling agent is a silane.

13. The rubber mixture according to claim 12, wherein an amount of said silane is 0-3 phr.

14. The rubber mixture according to claim 12, wherein an amount of said silane is 0.1-2 phr.

15. The rubber mixture according to claim 1, wherein that 0-10 phr of a total amount of said silica is not bonded to said polymer matrix.

16. The rubber mixture according to claim 1, wherein an amount of said carbon black is 25-35 phr.

17. The rubber mixture according to claim 16, wherein an amount of said carbon black is 25-32 phr.

18. The rubber mixture according to claim 1, wherein said carbon black has an iodine number less than or equal to 120 g/kg and a DBP number greater than or equal to 100 cm³/100 g.

19. The rubber mixture according to claim 18, wherein said carbon black has an iodine number less than or equal to 120 g/kg and a DBP number greater than or equal to 120 cm³/100 g.

20. The rubber mixture according to claim 1, wherein only a single carbon black type is used.

21. The rubber mixture according to claim 1, wherein said plasticizer oil is a mineral oil.

22. The rubber mixture according to claim 21, wherein said mineral oil is selected from the group consisting of DAE, RAE, TDAE, MES and naphthenic oils.

23. The rubber mixture according to claim 1, further comprising 0-5 phr of at least one further plasticizer.

24. The rubber mixture according to claim 23, wherein said further plasticizer is selected from the group consisting of synthetic plasticizers, fatty acids, fatty acid derivatives, resins and factices.

25. The rubber mixture according to claim 1, wherein the rubber mixture contains 0.2-8 phr of said zinc oxide.

26. The rubber mixture according to claim 25, wherein the rubber mixture contains 0.2-4 phr of said zinc oxide.

27. The rubber mixture according to claim 1, wherein a proportion of said further additives is 3-80 phr.

28. The rubber mixture according to claim 27, wherein a proportion of said further additives is 5-60 phr.

29. A production method, which comprises the steps of:
providing a rubber mixture containing 95-100 phr of at least one of natural polyisoprene and synthetic polyisoprene, 0-5 phr of at least one of a further polar rubber and a nonpolar rubber, 1-10 phr of silica, 20-40 phr of at least one carbon black with an iodine number less than or equal to 120 g/kg and a DBP number greater than or equal to 90 cm³/100 g, 0.1-5 phr of at least one plasticizer oil, 0.1-10 phr of zinc oxide, and 2-100 phr of further additives; and
forming parts of a tire from the rubber mixture.

30. The production method according to claim 29, which further comprises forming a tread of the tire from the rubber mixture.

31. The production method according claim 30, which further comprises forming a base of the tire from the rubber mixture.

32. The production method according claim 30, which further comprises producing a body mixture of the tire from the rubber mixture.

33. The production method according claim 32, which further comprises forming the body mixture of the tire to include at least one of sidewalls, an inner liner, an apex, a belt, shoulders, a belt profile, a squeegee, a carcass, a bead reinforcer and a bandage.

34. The production method according claim 29, which further comprises producing a belt of the tire from the rubber mixture.

35. The production method according claim 34, which further comprises producing a conveyor belt of the tire from the rubber mixture.

36. The production method according claim 35, which further comprises producing a running side of the conveyor belt from the rubber mixture.

37. The production method according claim 29, which further comprises producing a drive belt of the tire from the rubber mixture.

38. The production method according claim 37, which further comprises producing a flat belt of the tire from the rubber mixture.

39. The production method according claim 37, which further comprises producing a V belt of the tire from the rubber mixture.

40. The production method according claim 37, which further comprises producing a V-ribbed belt of the tire from the rubber mixture.

41. The production method according claim 37, which further comprises producing a toothed belt of the tire from the rubber mixture.
